(19) United States
(12) Patent Application Publication
(10) Pub. No.: US 2013/0032036 A1
(43) Pub. Date: Feb. 7, 2013

(54) NESPRESSO

(71) Applicants: Weijun ZHONG, Zhangshou (CN); Kuo Hsun LIN, Tainan County (TW)

(72) Inventors: Weijun ZHONG, Zhangshou (CN); Kuo Hsun LIN, Tainan County (TW)

(73) Assignee: TSANN KUEN (ZHANG ZHOU) ENTERPRISE CO., LTD., Zhangzhou (CN)

(21) Appl. No.: 13/563,565

(22) Filed: Jul. 31, 2012

(30) Foreign Application Priority Data
Aug. 2, 2011 (CN) 201120279758.5

(51) Int. Cl. A47J 31/54

(52) U.S. Cl. 99/294

(57) ABSTRACT

A nespresso coffee maker has, a water tank, a water pump, a flowmeter, a boiler, a solenoid valve and a capsule cup arranged in the shell. A gas pump and a water-gas output switching mechanism are arranged in the shell of the nespresso; one inlet of the water-gas output switching mechanism connects to the outlet pipe of the boiler, another inlet connects to the outlet pipe of the gas pump; the outlet of the water-gas output switching mechanism connects to the pipeline of the upper port of the capsule cup. After coffee is brewed and through the water-gas output switching mechanism, the outlet pipe of the boiler is closed, and the coffee liquid remaining in the capsule is blown out by the gas from the gas pump.

### FIELD OF THE INVENTION

The present invention relates to a nespresso.

### BACKGROUND OF THE INVENTION

The structure of waterway of the nespresso at the prior art is shown in FIG. 1: A water tank 1, a water pump 3, a flowmeter 4, a boiler 5, a solenoid valve 14, a check valve 521 and a capsule cup 6 are arranged in the shell of the nespresso. The outlet pipe 11 of the water tank 1 is communicated with the inlet 31 of the water pump 3. The outlet of the water pump 3 is communicated with the inlet pipe 41 of the flowmeter 4. The outlet 42 of the flowmeter 4 is communicated with the inlet pipe 51 of the boiler 5. The exhaust pipe 53 of the boiler 5 is communicated with the inlet of the solenoid valve 14, the outlet of the solenoid valve 14 is communicated with the second gas-returning pipe 13 of the water tank 1. The outlet pipe 52 of the boiler 5 is communicated with the pipeline 60 of the upper port of the capsule cup 6 through the check valve 521.A pipeline 64 communicating with the coffee outlet 65 is arranged at the bottom of the capsule cup 6. The pricking pin 61 at the bottom of the capsule cup 6 sticks into the interior of the capsule cup 6. When the capsule 62 is put into the internal cavity 63 of the capsule cup 6, the pricking pin 61 is lifted up by the pricking pin lifting mechanism and punctures the bottom of the capsule 62, and then the capsule 62 is lifted up by the pricking pin lifting mechanism and the top of capsule 6 is punctured by the pipeline 60. Once the hot water from the boiler 5 enters the internal cavity of the capsule 62 through the pipeline 60, the coffee powder in the capsule 62 will be thawed to generate coffee liquid; the coffee liquid falls into the coffee cup 7 out of the shell through the opening at the bottom of the capsule 62 punctured by the pricking pin 61, the pipeline 64 and the coffee outlet 65.

The circuit box structure of the nespresso at the prior is shown in FIG. 2: the three data collection ports of the controller 100 accept the flow signal from the flowmeter 4, the water temperature signal of the boiler 5 from the temperature sensor 57 and the water lever signal of the boiler 5 from the water lever sensor 56 respectively. One control input port of the controller 100 accepts the control signal from the flush button 101. The four control output ports of the controller 100 control the water pump 3, the solenoid valve 14, the water temperature indicator 102 and the boiler heater 55 respectively.

When the capsule 62 is put in the internal cavity 63 of the capsule cup 6 of the nespresso by the users, the top and the bottom of the capsule 62 are all punctured. When the nespresso is on, the controller 100 first controls the solenoid valve 14 to be on. And then the controller 100 gathers the water level signal in the boiler 5 from the water level sensor 56, and if the water level in the boiler 5 is lower than the provided level, then the water pump 3 is controlled to run by the controller 100, and water in the water tank 1 is pumped into the boiler 5. Because of certain preset pressure in the first check valve 521, the gas in the boiler 5 will not exhaust from the outlet pipe 52 of the boiler 5. Along with rising of the water level in the boiler 5, the gas in the boiler 5 is transmitted into the water tank 1 through the exhaust pipe 53 of the boiler 5, the solenoid valve 14 and the second gas-returning pipe 13 of the water tank 1.

When the water level in the boiler 5 gets to the provided water level, the water pump 3 is controlled to be at off state by the controller 100, and the boiler heater 55 is at heating state. During the heating process, the controller 100 gathers the water temperature signal in the boiler 5 from the temperature sensor 57. When the water temperature in the boiler 5 gets to the provided value, the boiler heater 55 is controlled to stop heating by the controller 100, and the water temperature indicator 102 gives the signal that the water temperature is at the provided value.

After that, if the users push the flush button 100, the controller 100 shuts down the solenoid valve 14, and starts the water pump 3, and keeps the boiler heater 55 heating, and the cold water in the water tank 1 is transmitted into the boiler 5, and then the hot water in the boiler 5 is forcibly transmitted into the internal cavity of the capsule 62 in the capsule cup 6 through the check valve 521 and the upper port of the capsule cup 6, and the coffee powder in the capsule 62 is thawed by the hot water, and the produced coffee liquid falls into the coffee cup 7 out of the shell through the pipeline 64 and the coffee outlet 65. The controller 100 gathers the flow signal from the flowmeter 4, when the water flow gets to the provided value of the coffee cup 7, the coffee liquid in the coffee cup 7 gets to the specified amount. The controller 100 stops the water pump 3, the hot water in the boiler 5 will not be transmitted into the internal cavity of the capsule 6 of the capsule cup 6 through the check valve 521 and the pipeline 60 of the upper port of the capsule cup 6, and no coffee liquid falls into the coffee cup 7 out of the shell through the pipeline 64 and the coffee outlet 65. At last, the controller 100 starts the solenoid valve 14, and keeps the heater 55 heating until the water temperature gets to the provided value, and then stops the heater 55 heating, so that the nespresso is ready for the users to change capsule 62 and brew coffee again.

There are still pluralities of defects in the nespresso at the prior: When changing the capsule 62, the coffee liquid drops anywhere, and pollutes the coffee cup 6, the shell and the surrounding environment.

### SUMMARY OF THE INVENTION

The object of the present invention is to offer a nespresso which can prevent the remaining coffee liquid from dropping when changing the capsule.

The technical proposal of the present invention is:

A nespresso, a water tank, a water pump, a flowmeter, a boiler, a solenoid valve and a capsule cup are arranged in the shell, wherein, a gas pump and a water-gas output switching mechanism are arranged in the shell of the nespresso; one inlet of the water-gas output switching mechanism is communicated with the outlet pipe of the boiler, another inlet is communicated with the outlet pipe of the gas pump; the outlet of the water-gas output switching mechanism is communicated with the pipeline of the upper port of the capsule cup.

When brewing coffee, the water-gas output switching mechanism closes the outlet pipe of the gas pump, so that the outlet pipe of the boiler is communicated with the pipeline of the upper port of the capsule cup, and the boiler supplies hot water to the capsule. After coffee liquid is brewed, the outlet pipe of the boiler is closed by the water-gas output switching mechanism, and the coffee liquid remaining in the capsule is blown out by the gas from the gas pump. During the capsule changing process, the remaining coffee liquid can be prevented from dropping and polluting the capsule cup, the shell and the surrounding environment.

The water-gas output switching mechanism comprises a first check valve, the second check valve and a three way pipe; the inlet end of the first check valve is communicated with the outlet pipe of the boiler; two ports of the three way pipe are communicated with the outlet end of the first check valve and the pipeline of the upper port of the capsule cup respectively, the third port of the three way pipe is communicated with the outlet end of the second check valve; the inlet end of the second check valve is communicated with the outlet pipe of the gas pump.

When brewing coffee, the gas pump is inactive; water-gas output switching mechanism is automatically at the state that the outlet of the gas pump is closed and the outlet pipeline of the boiler is communicated with the pipeline of the upper port of the capsule cup. The hot water from the outlet pipe of the boiler flows out from the first check valve, but does not enter the gas pump through the second check valve, and the said hot water can only be transmitted into the internal cavity of the capsule of the capsule cup through the three way pipe and the pipeline of the upper port of the capsule cup, and the coffee powder is thawed. When the amount of the coffee liquid in the coffee cup reaches the provided amount, the water pump stops transmitting water into the boiler, and the outlet pipe of the boiler no longer supplies pressure water for the first check valve to open the first check valve, and the first check valve closes the outlet pipe of the boiler. After the gas pump is started, the second check valve is opened by the gas pressure, the water-gas output switching mechanism is automatically at the state that the outlet pipe of the boiler is closed and the outlet pipe of the gas pump is communicated with the pipeline of the upper port of the capsule cup. Because the first check valve at the outlet pipe of the boiler closes the passage through which the gas from the gas pump flows to the outlet pipe of the boiler, the gas from the gas pump can only be transmitted into the internal cavity of the capsule in the capsule cup through the second check valve, the three way pipe and the pipeline of the upper port of the capsule cup, and the coffee liquid remaining in the capsule can be totally blown out and falls into the coffee cup out of the shell through the pipeline and the coffee outlet. So this kind of water-gas output switching mechanism is easy to maintain without external operation.

The water-gas output switching mechanism can also be a three-way change valve, two inlets of the three-way change valve are communicated with the outlet pipe of the boiler and the outlet pipe of the gas pump, the outlet of the three-way change valve is communicated with the pipeline of the upper port of the capsule cup.

When brewing coffee, the three-way change valve keeps the state that the outlet is communicated with the outlet pipe of the boiler, and the gas pump is inactive; the hot water from the outlet pipe of the boiler cannot enter the gas pump through the three-way change valve, and can only be transmitted into the internal cavity of the capsule in the capsule cup through the three-way change valve and the pipeline of the upper port of the capsule cup. When the amount of the coffee liquid in the coffee cup reaches the provided amount, the three-way change valve is switched to the state that its outlet is communicated with the outlet pipe of the gas pump, and the gas pump is active; because the outlet pipe of the boiler is closed by the three-way change valve, the gas from the gas pump can only be transmitted into the internal cavity of the capsule in the capsule cup through the three-way change valve and the pipeline of the upper port of the capsule cup, and the coffee liquid remaining in the capsule can be totally blown out and falls into the coffee cup out of the shell through the pipeline and the coffee outlet. Some external operation is needed in this kind of water-gas output switching mechanism, but the amount of the used pars is small with simple structure, and it is easy to produce and assemble.

Hot water from the outlet pipe of the boiler is chosen to be transmitted into the internal cavity of the capsule in the capsule cup by the water-gas output switching mechanism to brew coffee liquid in the nespresso in the present invention; or gas from the gas pump is chosen be transmitted into the internal cavity of the capsule in the capsule cup to blow out the coffee liquid remaining in the capsule totally, and the said coffee liquid falls into the coffee cup out of the shell through the pipeline and the coffee outlet. When changing the capsule, the coffee liquid will not drop anywhere, and pollutes the coffee cup, the shell and the surrounding environment, and the surrounding environment will be kept clean without unnecessary waste of the coffee liquid. In consequence, the nespresso in the present invention can keep the surrounding environment clean to build comfortable environment and rejoice the users; the waste of the coffee liquid is reduced to maximally utilize coffee.

### BRIEF DESCRIPTION OF THE DRAWINGS

FIG. 1 shows the abridged general view of the structure of the waterway in the nespresso at the prior art;

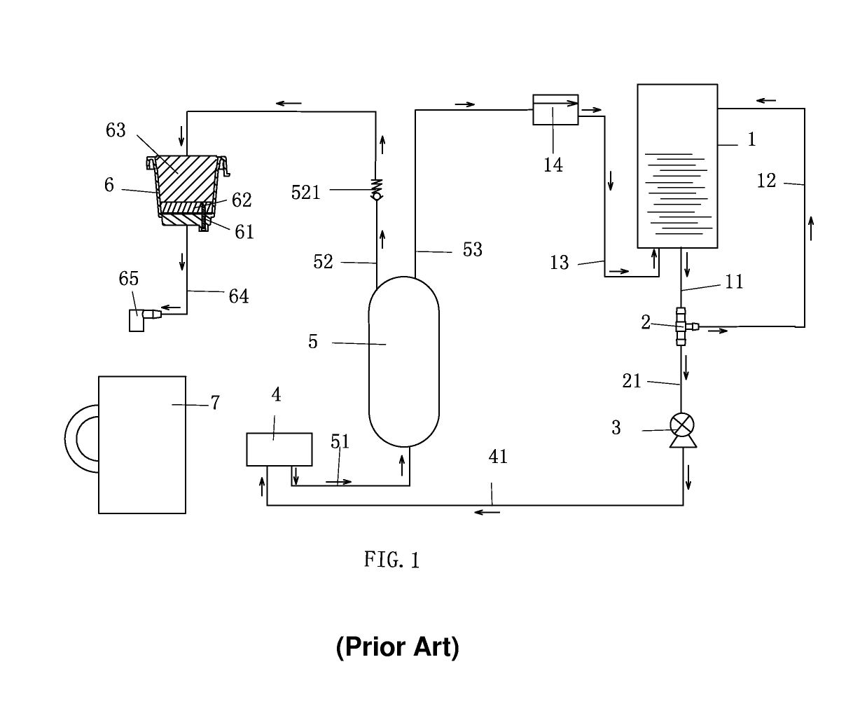

FIG. 2 shows the abridged general view of the circuit box structure of the nespresso at the prior art;

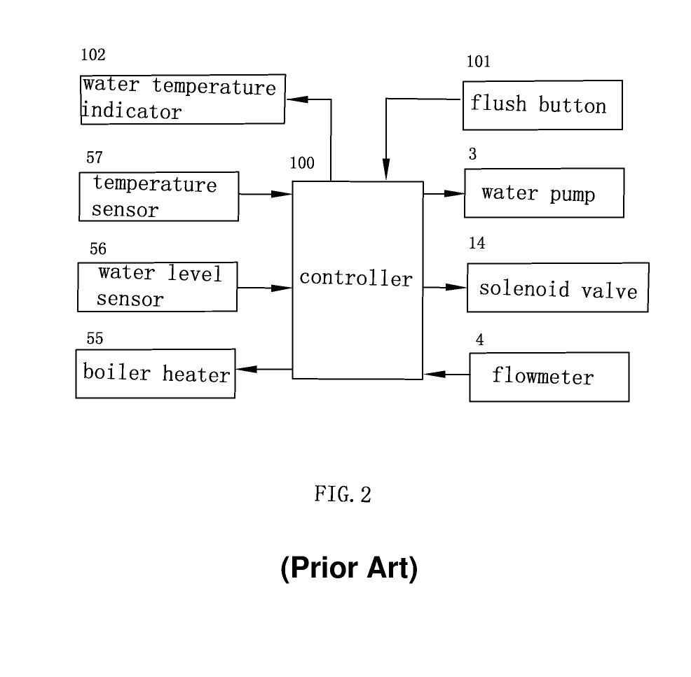

FIG. 3 shows the abridged general view of the structure of the waterway and gas circuit of the first embodiment of the nespresso in the present invention;

FIG. 4 shows the abridged general view of the circuit box structure of the embodiment in FIG. 3;

FIG. 5 shows the abridged general view of the structure of the waterway and gas circuit of the second embodiment of the nespresso in the present invention;

FIG. 6 shows the abridged general view of the circuit box structure of the embodiment in FIG. 5;

### DESCRIPTION OF THE PREFERRED EMBODIMENTS

### Embodiment 1

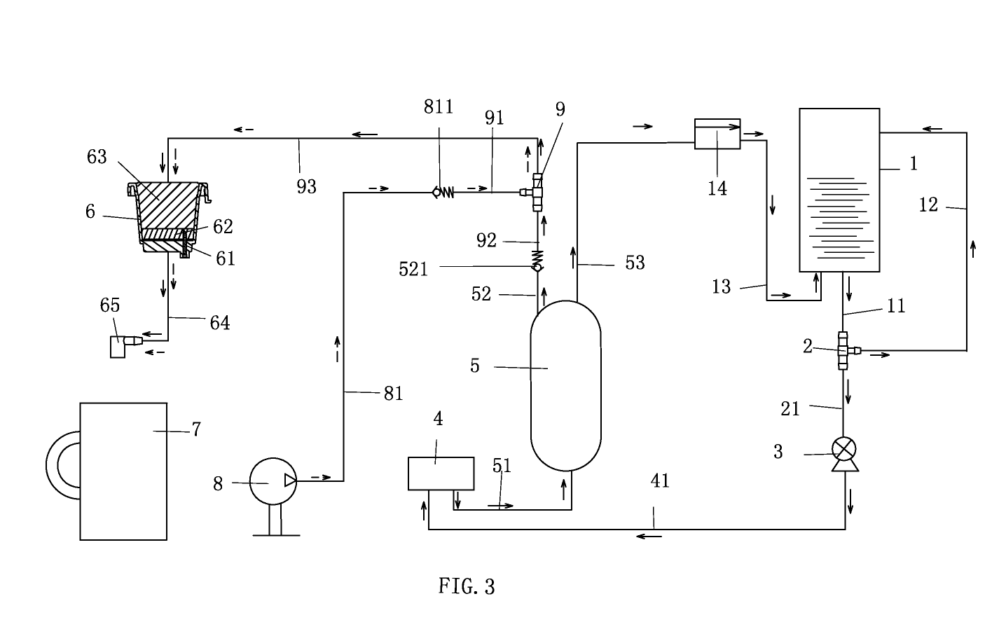

The structure of waterway and gas circuit of one embodiment of the nespresso in the present invention is shown in FIG. 3, wherein, the trend of the water way is shown as the full line with arrow, the trend of the gas circuit is shown as the dotted line with arrow. A water tank 1, a first three way pipe 2, a water pump 3, a flowmeter 4, a boiler 5, a solenoid valve 14, a capsule cup 6, a gas pump 8 and a water-gas output switching mechanism are arranged in the shell of the nespresso. The water-gas output switching mechanism comprises a first check valve 521, a second check valve 811 and a second three way pipe 9.

The outlet pipe 11 of the water tank 1 is communicated with the first port 21 of the first three way pipe 2. The second port 22 of the first three way pipe 2 is communicated with the first gas-returning pipe 12 of the water tank 1. The third port 23 of the first three way pipe 2 is communicated with the inlet 31 of the water pump 3. The first three way pipe 2 is used for exhausting the gas in the pipe line between the water tank 1 and the inlet of the water pump 3 into the water tank 1 through the first gas-returning pipe 12, so that the water pump 3 can works fine. The outlet of the water pump 3 is communicated with the inlet pipe 41 of the flowmeter 4. The outlet 42 of the flowmeter 4 is communicated with the inlet pipe 51 of the boiler 5. The exhaust pipe 53 of the boiler 5 is communicated with the inlet of the solenoid valve 14, the outlet of the solenoid valve 14 is communicated with the second gas-returning pipe 13 of the water tank 1. The solenoid valve 14 is used for controlling the gas in the boiler to enter the water tank 1 through the second gas-returning pipe 13 and preventing hot water from entering the water tank 1 through the second gas-returning pipe 13.

The outlet pipe 52 of the boiler 5 is communicated with the inlet end of the first check valve 521; the outlet end of the first check valve 521 is communicated with the first port 91 of the second three way pipe 9, the second port 92 of the second three way pipe 9 is communicated with pipeline 60 of the upper port of the capsule cup 6 through pipeline, the third port 93 of the second three way pipe 9 is communicated with the outlet end of the second check valve 811. The inlet end of the second check valve 811 is communicated with the outlet pipe 81 of the gas pump 8.

A pipeline 64 communicating with the coffee outlet 65 is arranged at the bottom of the capsule cup 6. The pricking pin 61 at the bottom of the capsule cup 6 sticks into the interior of the capsule cup 6. When the capsule 62 is put into the internal cavity 63 of the capsule cup 6, the pricking pin 61 is lifted up by the pricking pin lifting mechanism and punctures the bottom of the capsule 62, and then the capsule 62 is lifted up by the pricking pin lifting mechanism and the top of capsule 6 is punctured by the pipeline 60. Once the hot water from the boiler 5 enters the internal cavity of the capsule 62 through the pipeline 60, the coffee powder in the capsule 62 will be thawed to generate coffee liquid; the coffee liquid falls into the coffee cup 7 out of the shell through the opening at the bottom of the capsule 62 punctured by the pricking pin 61, the pipeline 64 and the coffee outlet 65.

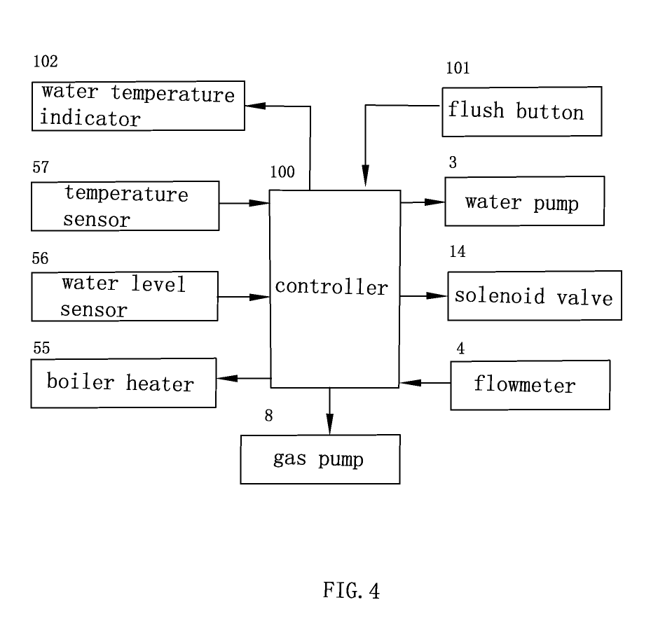

The circuit box structure of the present embodiment is shown in FIG. 4: the three data collection ports of the controller 100 accept the flow signal from the flowmeter 4, the water temperature signal of the boiler 5 from the temperature sensor 57 and the water lever signal of the boiler 5 from the water lever sensor 56 respectively. One control input port of the controller 100 accepts the control signal from the flush button 101. The five control output ports of the controller 100 control the water pump 3, the gas pump 8, the solenoid valve 14, the water temperature indicator 102 and the boiler heater 55 respectively.

When the capsule 62 is put in the internal cavity 63 of the capsule cup 6 of the nespresso by the users, the top and the bottom of the capsule 62 are all punctured. When the nespresso is on, the controller 100 first control the solenoid valve 14 to be on, and the gas pump 8 is at halted state. And then the controller 100 gathers the water level signal in the boiler 5 from the water level sensor 56, and if the water level in the boiler 5 is lower than the provided level, then the water pump 3 is controlled to run by the controller 100, and water in the water tank 1 is pumped into the boiler 5. Because of certain preset pressure in the first check valve 521, the gas in the boiler 5 will not exhaust from the outlet pipe 52 of the boiler 5. Along with rising of the water level in the boiler 5, the gas in the boiler 5 is transmitted into the water tank 1 through the exhaust pipe 53 of the boiler 5, the solenoid valve 14 and the second gas-returning pipe 13 of the water tank 1.

When the water level in the boiler 5 gets to the provided water level, the water pump 3 is controlled to be at off state by the controller 100, and the boiler heater 55 is at heating state. During the heating process, the controller 100 gathers the water temperature signal in the boiler 5 from the temperature sensor 57. When the water temperature in the boiler 5 gets to the provided value, the boiler heater 55 is controlled to stop heating by the controller 100, and the water temperature indicator 102 gives the signal that the water temperature is at the provided value.

After that, if the users push the flush button 100, the controller 100 shuts down the solenoid valve 14, and starts the water pump 3, and keeps the boiler heater 55 heating, and the cold water in the water tank 1 is transmitted into the boiler 5, the pressure that water in the boiler 5 gives to the first check valve 521 is bigger than the preset pressure, and then the hot water in the boiler 5 is forcibly transmitted into the internal cavity of the capsule 62 in the capsule cup 6 through the check valve 521 and the upper port of the capsule cup 6, and the coffee powder in the capsule 62 is thawed by the hot water, and the produced coffee liquid falls into the coffee cup 7 out of the shell through the pipeline 64 and the coffee outlet 65. When brewing coffee, the gas pump 8 is inactive; the outlet pipe 81 of the gas pump is automatically sealed by the second check valve 811 of the water-gas output switching mechanism under its own preset pressure. Because the outlet pipe 52 of the boiler 5 is communicated with the pipeline 60 of the upper port of the capsule cup 6 at this moment, the hot water from the outlet pipe 52 of the boiler 5 flows through the first check valve 521 and the second three way pipe 9 to thaw the coffee powder in the internal cavity of the capsule 62 in the capsule cup 6 and to produce coffee liquid, but does not enter the gas pump 8 through the second check valve 811. The controller 100 gathers the flow signal from the flowmeter 4, when the water flow gets to the provided value of the coffee cup 7, the coffee liquid in the coffee cup 7 gets to the specified amount. The controller 100 stops the water pump 3, and the water pump 3 stops transmitting water into the boiler 5, the outlet pipe 52 of the boiler 5 no longer provides water of which pressure exceed the preset pressure of the first check valve 521 and by which the first check valve 521 is opened to the first check valve 521, and the first check valve 521 close the outlet pipe 52 of the boiler. The water-gas output switching mechanism is automatically at the state that the outlet pipe 52 of the boiler 5 is closed. The hot water in the boiler 5 will not be transmitted into the internal cavity of the capsule 6 of the capsule cup 6 through the check valve 521 and the pipeline 60 of the upper port of the capsule cup 6, and no coffee liquid falls into the coffee cup 7 out of the shell through the pipeline 64 and the coffee outlet 65.

At this moment, the controller 100 starts the gas pump 8, the second check valve 811 is opened by the gas pressure that exceeds the preset pressure of the check valve 811 from the outlet pipeline 81, and the water-gas output switching mechanism is automatically at the state that the outlet pipeline 81 of the gas pump 8 is communicated with the pipeline 60 of the upper port of the capsule 6. Because the first check valve 521 of the outlet pipeline 52 of the boiler 5 closes the passage through which the gas from the gas pump 8 flows to the outlet pipeline 52 of the boiler 5, the gas from the gas pump 8 can only be transmitted into the internal cavity of the capsule 62 in the capsule cup 6 through the second check valve 811, the second three way pipe 9 and the pipeline 60 of the upper port of the capsule cup 6, and the coffee liquid remaining in the capsule 62 is totally blown out and falls into the coffee cup 7 out of the shell through the crevasse at the bottom of the capsule 62, the pipeline 64 and the coffee outlet 65.

At last, the controller 100 stops the gas pump 8, and starts the solenoid valve 14, and keeps the heater 55 heating until the water temperature gets to the provided value, and then stops the heater 55 heating, so that the nespresso is ready for the users to change capsule 62 and brew coffee again. When changing the capsule 62, the coffee liquid will not drop anywhere, and pollutes the coffee cup 6, the shell and the surrounding environment, and the surrounding environment will be kept clean without unnecessary waste of the coffee liquid. In consequence, the nespresso in the present invention can keep the surrounding environment clean to build comfortable environment and rejoice the users; the waste of the coffee liquid is reduced to maximally utilize coffee.

### Embodiment 2

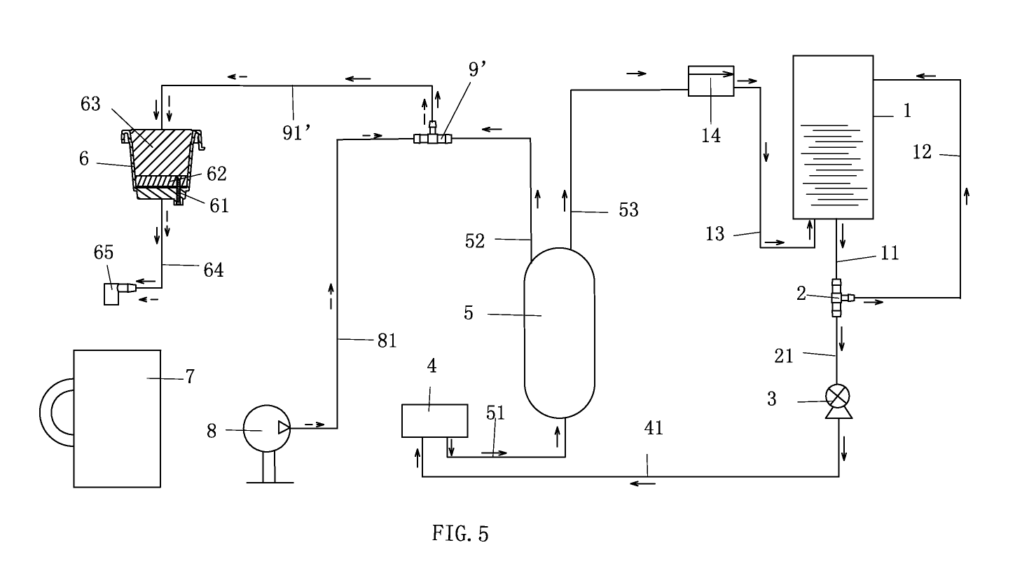

The structure of waterway and gas circuit of another embodiment of the nespresso in the present invention is shown in FIG. 5, wherein, the trend of the water way is shown as the full line with arrow, the trend of the gas circuit is shown as the dotted line with arrow. A water tank 1, a first three way pipe 2, a water pump 3, a flowmeter 4, a boiler 5, a solenoid valve 14, a capsule cup 6, a gas pump 8 and a water-gas output switching mechanism (three-way change valve) are arranged in the shell of the nespresso.

The waterway communicating relationship of the water tank 1, the first three way pipe 2, the water pump 3, the flowmeter 4, the boiler 5 and the solenoid valve 14 in the present embodiment is same as that in the previous embodiment.

In the present embodiment, the first inlet 91′ of the three-way change valve 9′ is communicated with the outlet pipe 52 of the boiler 5, the second inlet 92′ of the three-way change valve 9′ is communicated with the outlet pipe 81 of the gas pump 8, and the outlet 93′ of the three-way change valve 9′ is communicated with the pipeline 60 of the upper port of the capsule cup 6. A pipeline 64 communicating with the coffee outlet 65 is arranged at the bottom of the capsule cup 6. The pricking pin 61 at the bottom of the capsule cup 6 sticks into the interior of the capsule cup 6. When the capsule 62 is put into the internal cavity 63 of the capsule cup 6, the pricking pin 61 is lifted up by the pricking pin lifting mechanism and punctures the bottom of the capsule 62, and then the capsule 62 is lifted up by the pricking pin lifting mechanism and the top of capsule 6 is punctured by the pipeline 60. Once the hot water from the boiler 5 enters the internal cavity of the capsule 62 through the pipeline 60, the coffee powder in the capsule 62 will be thawed to generate coffee liquid; the coffee liquid falls into the coffee cup 7 out of the shell through the opening at the bottom of the capsule 62 punctured by the pricking pin 61, the pipeline 64 and the coffee outlet 65.

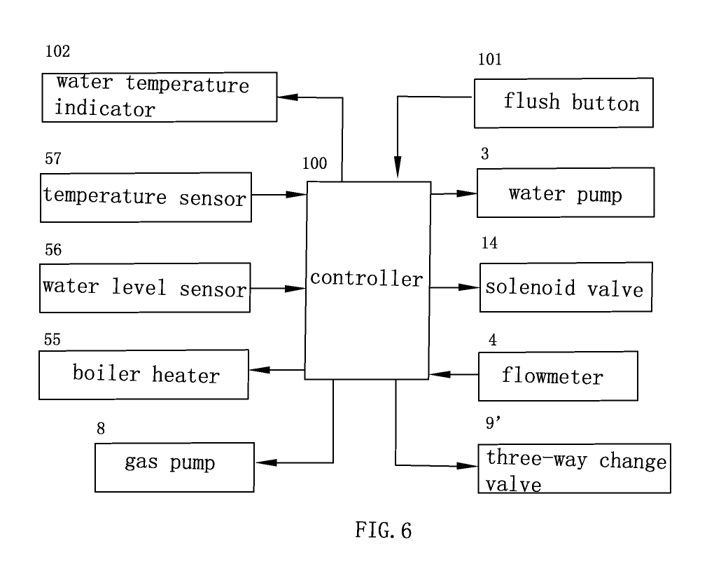

The circuit box structure of the present embodiment is shown in FIG. 6: the three data collection ports of the controller 100 accept the flow signal from the flowmeter 4, the water temperature signal of the boiler 5 from the temperature sensor 57 and the water lever signal of the boiler 5 from the water lever sensor 56 respectively. One control input port of the controller 100 accepts the control signal from the flush button 101. The six control output ports of the controller 100 control the water pump 3, the gas pump 8, the three-way change valve 9′, the solenoid valve 14, the water temperature indicator 102 and the boiler heater 55 respectively.

When the capsule 62 is put in the internal cavity 63 of the capsule cup 6 of the nespresso by the users, the top and the bottom of the capsule 62 are all punctured. When the nespresso is on, the controller 100 first control the solenoid valve 14 to be on, and the three-way change valve 9′ is controlled at the state that the first inlet 91′ and the corresponding outlet pipeline 52 of the boiler are closed and the second inlet 92′ and the corresponding outlet pipeline 81 of the gas-pump 8 are being communicated with the outlet 93′ of the three-way change valve 9′, and the gas pump 8 is inactive. And then the controller 100 gathers the water level signal in the boiler 5 from the water level sensor 56, and if the water level in the boiler 5 is lower than the provided level, then the water pump 3 is controlled to run by the controller 100, and water in the water tank 1 is pumped into the boiler 5. Because the three-way change valve 9′ closes the outlet pipe 52 of the boiler 5, the gas in the boiler 5 will not exhaust from the outlet pipe 52 of the boiler 5. Along with rising of the water level in the boiler 5, the gas in the boiler 5 is transmitted into the water tank 1 through the exhaust pipe 53 of the boiler 5, the solenoid valve 14 and the second gas-returning pipe 13 of the water tank 1.

When the water level in the boiler 5 gets to the provided water level, the water pump 3 is controlled to be at off state by the controller 100, and the boiler heater 55 is at heating state. During the heating process, the controller 100 gathers the water temperature signal in the boiler 5 from the temperature sensor 57. When the water temperature in the boiler 5 gets to the provided value, the boiler heater 55 is controlled to stop heating by the controller 100, and the water temperature indicator gives the signal that the water temperature is at the provided value.

After that, if the users push the flush button 100, the controller 100 shuts down the solenoid valve 14, and the three-way change valve 9′ is switched to the state that second inlet 92′ and the corresponding outlet pipe 81 of the gas pump 8 are closed and the first inlet 91′ and the corresponding outlet pipe 52 of the boiler 5 are being communicated with the outlet 93′ of the three-way change valve 9′, and the water pump 3 is started, and the boiler heater 55 keeps heating, and the cold water in the water tank 1 is transmitted into the boiler 5, and then the hot water in the boiler 5 is forcibly transmitted into the internal cavity of the capsule 62 in the capsule cup 6 through first inlet 91′ of the three-way change valve 9′, the outlet 93′ and the pipeline 60 of the upper port of the capsule cup 6, and the coffee powder in the capsule 62 is thawed by the hot water, and the produced coffee liquid falls into the coffee cup 7 out of the shell through the crevasse at the bottom of the capsule 62, the pipeline 64 and the coffee outlet 65. When brewing coffee, the three-way change valve 9′ keeps the state that the outlet 93′ is being communicated with the first inlet 91′ and the corresponding outlet pipe 52 of the boiler 5, and the gas pump Bis inactive; the hot water from the outlet pipe 52 of the boiler 5 cannot enter the gas pump 8 through the three-way change valve 9′, and can only be transmitted into the internal cavity of the capsule 62 in the capsule cup 6 through the first inlet 91′ of the three-way change valve 9′, the outlet 93′ and the pipeline 60 of the upper port of the capsule cup 6.The controller 100 gathers the flow signal from the flowmeter 4, when the water flow gets to the provided value of the coffee cup 7, the coffee liquid in the coffee cup 7 gets to the specified amount. The controller 100 stops the water pump 3, and the water pump 3 stops transmitting water into the boiler 5, and the controller 100 switches the three-way change valve 9′ to the state that the outlet 93′ is being communicated with the second inlet 92′ and the corresponding outlet pipe 81 of the gas pump 8, and the three-way change valve 9′ closes the outlet pipe 52 of the boiler 5.The hot water in the boiler 5 will not be transmitted into the internal cavity of the capsule 6 of the capsule cup 6 through the outlet 93′ of the three-way change valve 9′ and the pipeline 60 of the upper port of the capsule cup 6, and no coffee liquid falls into the coffee cup 7 out of the shell through the crevasse at the bottom of the capsule 62, the pipeline 64 and the coffee outlet 65.At the same time, the controller 100 starts the gas pump 8, and because the outlet pipe 52 of the boiler 5 is closed by the three-way change valve, the gas from the gas pump 8 can only be transmitted into the internal cavity of the capsule 62 in the capsule cup 6 through the outlet 93′ of the three-way change valve 9′ and the pipeline 60 of the upper port of the capsule cup 6, and the coffee liquid remaining in the capsule 62 is totally blown out and falls into the coffee cup 7 out of the shell through the crevasse at the bottom of the capsule 62, the pipeline 64 and the coffee outlet 65.

At last, the controller 100 stops the gas pump 8, and starts the solenoid valve 14, and keeps the heater 55 heating until the water temperature gets to the provided value, and then stops the heater 55 heating, so that the nespresso is ready for the users to change capsule 62 and brew coffee again. When changing the capsule 62, the coffee liquid will not drop anywhere, and pollutes the coffee cup 6, the shell and the surrounding environment, and the surrounding environment will be kept clean without unnecessary waste of the coffee liquid. In consequence, the nespresso in the present invention can keep the surrounding environment clean to build comfortable environment and rejoice the users; the waste of the coffee liquid is reduced to maximally utilize coffee.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

What is claimed is:

1. A nespresso, a water tank, a water pump, a flowmeter, a boiler, a solenoid valve and a capsule cup are arranged in the shell, wherein, a gas pump and a water-gas output switching mechanism are arranged in the shell of the nespresso; one inlet of the water-gas output switching mechanism is communicated with the outlet pipe of the boiler, another inlet is communicated with the outlet pipe of the gas pump; the outlet of the water-gas output switching mechanism is communicated with the pipeline of the upper port of the capsule cup.

2. A nespresso according to claim 1, wherein, the water-gas output switching mechanism comprises a first check valve, the second check valve and a three way pipe; the inlet end of the first check valve is communicated with the outlet pipe of the boiler; two ports of the three way pipe are communicated with the outlet end of the first check valve and the pipeline of the upper port of the capsule cup respectively, the third port of the three way pipe is communicated with the outlet end of the second check valve; the inlet end of the second check valve is communicated with the outlet pipe of the gas pump.

3. A nespresso according to claim 1, wherein, the water-gas output switching mechanism is a three-way change valve, two inlets of the three-way change valve are communicated with the outlet pipe of the boiler and the outlet pipe of the gas pump, the outlet of the three-way change valve is communicated with the pipeline of the upper port of the capsule cup.
